(19) United States
(12) Patent Application Publication
(10) Pub. No.: US 2006/0146804 A1
(43) Pub. Date: Jul. 6, 2006

(54) Telephone system, switching system and management method of telephone system

(75) Inventor: Takahiro Ozaki, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/299,696

(22) Filed: Dec. 13, 2005

(30) Foreign Application Priority Data
Dec. 13, 2004 (JP) P2004-360129

(51) Int. Cl. H04L 12/66; H04L 12/56

(52) U.S. Cl. 370/352; 370/401

(57) ABSTRACT

A switching system includes plural communication interfaces, a detection unit, a terminal setting database, a judgment unit, a determination unit and a send-back unit. The communication interfaces accommodate plural terminal devices under accommodation modes each selected for each terminal device from the group consisting of a first mode in which the communication interfaces are explicitly assigned to the terminal devices and a second mode in which the communication interfaces are unexplicitly assigned to the terminal devices. The database associates each terminal device with the accommodation mode and the communication interface. When the judgment unit judges that the accommodation mode of each terminal device is the first mode and failure occurs in a communication interface having been assigned to each terminal device, the determination unit determines another communication interface from among communication interfaces in which the detection unit detects that failure does not occur.

This application is based upon and claims the benefit of priority from the prior Japanese Patent Application No. 2004-360129 filed on Dec. 13, 2004, the entire contents of which are incorporated herein by reference.

### BACKGROUND OF THE INVENTION

1. Field of the Invention

The present invention relates to a telephone system used in a business telephone system, etc., and a switching system, a terminal device provided in the telephone system and a management method of a telephone system. Particularly, the invention relates to a system for performing voice communication between terminals by using an IP (Internet Protocol).

2. Description of the Related Art

JP 2002-271399 A discloses a system for performing voice information communication through a best effort type communication network such as the Internet. This type system is also referred to as an IP telephone system or a VoIP (Voice over IP). This technique is also applied to a local communication network such as a private-line telephone network. Hereinafter, each telephone terminal in this type system will be particularly referred to as “IP telephone terminal” and a system formed in a local area will be referred to as “private-line IP telephone system”.

The private-line IP telephone system includes a plurality of IP telephone terminals, and an exchange for accommodating the IP telephone terminals through a communication network such as an LAN (Local Area Network) The exchange includes interfaces (boards) for accommodating the IP telephone terminals. Generally, a plurality of interfaces are used. This is because the number of terminals allowed to be accommodated in each interface is limited. In order to accommodate each terminal in any of the plurality of interfaces, it is therefore necessary to determine association therebetween, that is, determine an interface for accommodating each IP telephone terminal. The following two methods are used for the determination.

The first method is a method of registering destination interface information (such as IP address, etc.) in each IP telephone terminal in advance. When the registration is completed, the accommodation interface information (such as interface number, etc.) of each IP telephone terminal in a database of the exchange is updated automatically. The second method is a method of registering accommodation interface information of each IP telephone terminal in a database of the exchange in advance. A connection request from each IP telephone terminal involved in the registration is sent by means of broadcasting or multicasting. When the registration is completed, the destination interface information in the IP telephone terminal is updated automatically. Either of these methods requires a user's manual operation.

### SUMMARY OF THE INVENTION

As described above, a destination for accommodating each IP telephone terminal is set fixedly in advance before use. If the interface configuration (intra-apparatus configuration) in the exchange such as extension of a board needs to be changed, it is necessary to change the interfaces for accommodating the registered IP telephone terminals. In this case, the interface for accommodating each terminal can be changed intentionally in such a manner that each IP telephone terminal changes the destination interface and updates the database in the exchange in this process, the exchange first issues an instruction to the IP telephone terminal to change the destination interface. In accordance with the instruction, the IP telephone terminal performs a process of re-connection to the designated interface. Thus, this processing is completed.

In the aforementioned method, however, no consideration is given to the case where failure occurs in any one of the interfaces of the exchange. Accordingly, even in such an emergency, the procedure of updating the database still has to depend on the first or second method to thereby bring lack of speediness. Because an IP telephone terminal accommodated in the failure interface cannot be used until the aforementioned procedure is completed, it cannot help but be said that there is a defect in maintainability.

The invention has been made under the aforementioned circumstance. The invention provides a telephone system in which a destination for accommodating each telephone terminal can be changed immediately even at the time of occurrence of failure in any interface so that maintainability can be improved, and also provides a switching system and a terminal device used in the telephone system.

According to one embodiment of the invention, a telephone system includes a plurality of terminal devices and a switching system. Each terminal device transmits/receives packetized voice information to/from a destination terminal device through a packet communication network. The switching system connects the plurality of terminal devices to each other. The switching system includes a plurality of communication interfaces, a detection unit, a terminal setting database, a judgment unit, a determination unit and a send-back unit. The plurality of communication interfaces accommodate the plurality of terminal devices under accommodation modes, each of which is selected for each terminal device from the group consisting of a first mode in which the communication interfaces are explicitly assigned to the plurality of terminal devices and a second mode in which the communication interfaces are unexplicitly assigned to the plurality of terminal devices. The detection unit detects whether or not failure occurs in each communication interface. The terminal setting database associates each terminal device with the accommodation mode selected for each terminal device and the communication interface accommodating each terminal device. Upon reception of a connection request message transmitted from each terminal device, the judgment unit judges the accommodation mode of each terminal device by referring to the terminal setting database. When the judgment unit judges that the accommodation mode of each terminal device is the first mode and failure occurs in a communication interface having been assigned to each terminal device, the determination unit determines another communication interface, which accommodates each terminal device, from among communication interfaces in which the detection unit detects that failure does not occur. The send-back unit sends a response message including an identifier of the communication interface determined by the determination unit to each terminal device through the packet communication network. Each terminal device includes a transmission unit. The transmission unit transmits the connection request message to the communication interface assigned to each of the terminal devices under the first mode and transmits the connection request message to at least one of the communication interfaces under the second mode. When each of the terminal devices has not received the response message to the connection request message even if the transmission unit has transmitted the connection request message predetermined number of times, the transmission unit transmits the connection request message to at least one of the communication interfaces except the communication interface assigned to the each of the terminal devices.

When such a measure is taken, each terminal device is accommodated in the switching system under the first or second mode. Either mode can be selected (set) for each terminal by a user's operation. The switching system monitors failure/non-failure of each communication interface, for example, periodically.

Each terminal device can detect occurrence of failure in a communication interface accommodating each terminal device on the basis of the fact that there is no response to a connection request message. When there is no response message sent back in spite of repetition of a transmission trial plural times, the terminal device broadcasts a connection request message, for example, to all of the communication interfaces. Upon reception of the connection request message, the switching system determines a communication interface being able to accommodate the terminal device, and then sends a response message indicating this determination back to the terminal device.

Accordingly, when failure occurs in any communication interface, the destination of the terminal device connected to the failure communication interface is changed immediately. Moreover, the accommodation communication interface can be assigned (set) explicitly in the first mode. Thus, either of the first mode for fixedly assigning the accommodation interface for the terminal device and the second mode for automatically assigning the accommodation interface can be used properly. Accordingly, there can be obtained a new advantage that maintainability at the time of unintentionally changing the accommodation interface to avoid failure of any accommodation interface is improved while maintainability at the time of intentionally changing the accommodation interface for the terminal device is kept as good as in the existing system.

According to the configuration described above, it is possible to provide a telephone system in which a communication interface accommodating each telephone terminal can be changed immediately even at the time of occurrence of failure in any interface to thereby improve maintainability, and to provide a switching system, a terminal device used in the telephone system and a management method of a telephone system.

### BRIEF DESCRIPTION OF THE DRAWINGS

FIG. 1 is a functional block diagram showing a telephone system according to an embodiment of the invention.

FIG. 2 is a flow chart showing a procedure of processing in an exchange 200 in FIG. 1.

FIG. 3 is a flow chart showing a procedure of processing in the exchange 200 in FIG. 1.

FIG. 4 is a flow chart showing a procedure of processing in an IP telephone terminal 101 in FIG. 1.

FIG. 5 is a typical view showing a process at the time of occurrence of failure.

FIG. 6 is a flow chart showing a procedure of processing in the IP telephone terminal 101 in FIG. 1.

FIG. 7 is a flow chart showing a procedure of processing in the exchange 200 in FIG. 1.

FIG. 8 is a flow chart showing a procedure of processing in the IP telephone terminal 101 in FIG. 1.

FIG. 9 is a block diagram showing another embodiment of the invention.

### DETAILED DESCRIPTION OF EMBODIMENTS OF THE INVENTION

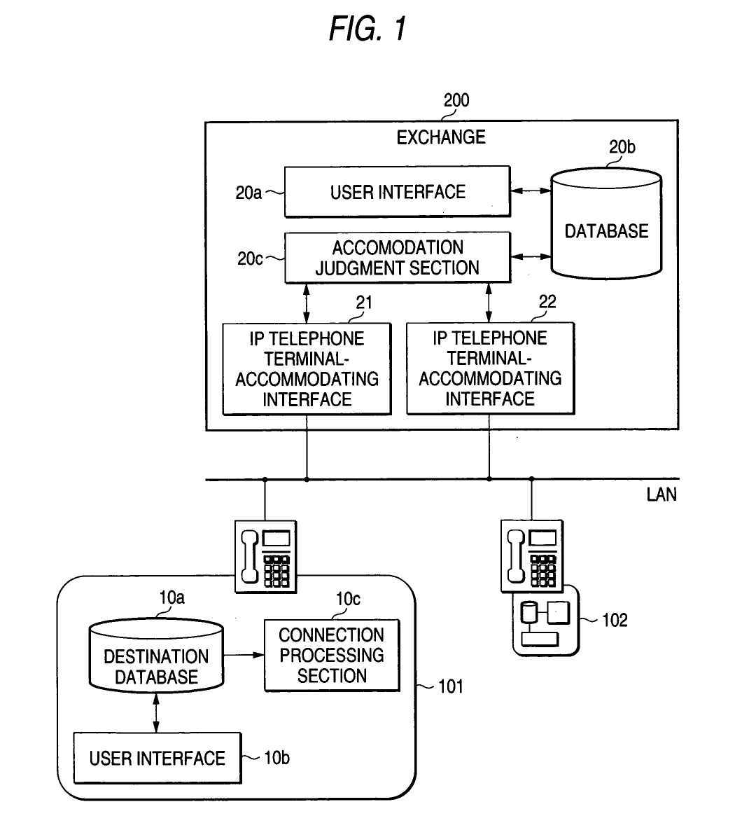

FIG. 1 is a functional block diagram showing a telephone system according to an embodiment of the invention. This system includes an exchange 200 (serving as a switching system), and a plurality of IP telephone terminals 101 and 102 connected to the exchange 200 through an LAN (Local Area Network). The IP telephone terminals 101 and 102 transmit/receive packetized voice data through the LAN to thereby form a so-called VoIP system. The exchange 200 executes a control process such as a band securing process and a call connection process to establish voice communication between the IP telephone terminals 101 and 102.

In FIG. 1, the IP telephone terminal 101 has a destination database 10a, a user interface 10b, and a connection processing section 10c. An IP address of a destination interface for accommodating the IP telephone terminal 101 is stored in the destination database 10a. Incidentally, the destination database 10a may store no storage content at the time of initial setting. The user interface 10b accepts a user's operation such as an operation of changing the destination interface.

The user interface 10b gives the user an interface for setting information (IP address, etc.) of the IP telephone terminal-accommodating interface (exchange 200), which is a destination of connection of the IP telephone terminal 101. The connection processing section 10c transmits a connection request to the exchange 200 at the time of initial setting or periodically. Incidentally, the IP telephone terminal 102 also has the same configuration. Incidentally, the “connection” in this embodiment is a concept including not only so-called “call connection” at the time of voice communication but also setting of correspondence relation between an IP telephone terminal and an accommodating interface.

The exchange 200 has a plurality of IP telephone terminal-accommodating interfaces 21 and 22, a user interface 20a, a database 20b, and an accommodation judgment section 20c. The IP telephone terminal-accommodating interfaces 21 and 22 are interfaces for accommodating the IP telephone terminals 101 and 102. Each of the IP telephone terminals 101 and 102 can be accommodated in either of the IP telephone terminal-accommodating interfaces 21 and 22. The correspondence relation between the IP telephone terminals and the IP telephone terminal-accommodating interfaces is one-to-one or many-to-one. That is, each of the IP telephone terminals 101 and-102 is stored in either of the IP telephone terminal-accommodating interfaces 21 and 22.

The database 20b is a database for associating an accommodation mode selected for each of the IP telephone terminals 101 and 102 with the IP addresses of the communication interfaces assigned to each of the IP telephone terminals 101 and 102. In this embodiment, two accommodation modes are defined, that is, a user designation mode (serving as a first mode) and an automatic assignment mode (serving as a second mode) are defined. Each of the IP telephone terminals 101 and 102 is accommodated in the exchange 200 under either of these modes. Under the user designation mode, an accommodation interface accommodating each IP telephone terminal is explicitly set according to user's designation. Under the automatic assignment mode, an accommodation interface accommodating each IP telephone terminal is set unexplicitly, that is, the accommodation interface accommodating each IP telephone terminal is determined at the initiative of the exchange 200. The accommodation interface accommodating each IP telephone terminal under the user designation mode is registered in the database 20b in advance. On the other hand, the accommodation interface accommodating each IP telephone terminal under the automatic assignment mode is not always registered in the database 20b.

Upon reception of a connection request from an IP telephone terminal, the accommodation judgment section judges the accommodation mode of the IF telephone terminal, which is a sender of the connection request, by referring to the database 20b. When the accommodation mode of the IP telephone terminal is the automatic assignment mode, the accommodation judgment section 20c selects/determines an accommodation interface from among the IP telephone terminal-accommodating interfaces 21 and 22. Even when the accommodation mode is the user designation mode, if failure occurs in the designated interface, the accommodation judgment section 20c selects/determines an interface in which failure does not occur, as an accommodation interface.

The user interface 20a is a human-machine interface used for changing the accommodation interfaces for the IP telephone terminals 101 and 102 at the exchange 200 end. The user interface 20a is used for reading or changing information of the database 20b (e.g., an accommodation mode for each IP telephone terminal and an accommodation interface for each IP telephone terminal) by a user's operation. Moreover, the user interface 20a gives the user an interface for reading the destination database 10a remotely.

The user interface 20a gives the user an interface requesting to set the accommodation interface for an IP telephone terminal with respect to which the user designation mode is selected as the accommodation mode. In addition, the user interface 20a gives the user an interface for changing the accommodation mode for each IP telephone terminal and an interface for changing information about an accommodation interface of an IP telephone terminal with respect to which the user designation mode is selected as the accommodation mode. Here, whenever the user changes the accommodation mode of a certain IP telephone terminal to the user designation mode, an accommodation interface for the IP telephone terminal is always newly designated. Next, an operation of the configuration will be described.

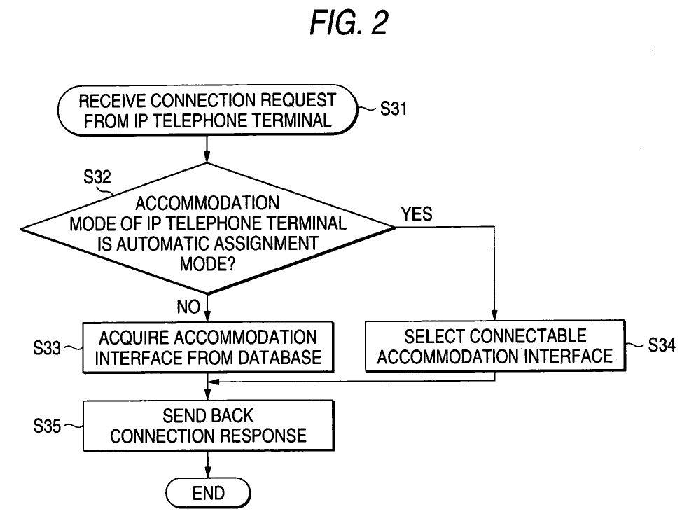

FIG. 2 is a flow chart showing a procedure of processing in the exchange 200 shown in FIG. 1. In FIG. 2, when a connection request from an IP telephone terminal reaches an IP telephone terminal-accommodating interface through the LAN (step S31), the accommodation judgment section 20c is informed of various pieces of information contained in the connection request. The accommodation judgment section 20c searches the database 20b to judge the accommodation mode of the IP telephone terminal, which is the sender of the connection request (step S32).

When the accommodation mode is the user designation mode (No at step S32), the accommodation judgment section 20c acquires an IP address of the accommodation interface for the IP telephone terminal by referring to the database 20b (step S33) The accommodation judgment section 20c sends a connection response including the acquired IP address of the accommodation interface back to the IP telephone terminal, which is the sender of the connection request (step S35) The connection response is sent back through the IP telephone terminal-accommodating interface, which received the connection request. Incidentally, the IP telephone terminal-accommodating interface, which received the connection request from the IP telephone terminal, is not always identical to the accommodation interface for accommodating the IP telephone terminal.

On the other hand, when the accommodation mode of the IP telephone terminal, which is the sender of the connection request, is the automatic assignment mode (Yes at step S32), the accommodation judgment section 20c checks whether an accommodation interface has been assigned to the IP telephone terminal or not, by referring to the database 20b. When it is found from a result of the checking that an accommodation interface has been already assigned, a connection response including the IP address of the assigned accommodation interface is sent back to-the IP telephone terminal, which is the sender of the connection request.

When it is found from a result of the checking that no accommodation interface has been assigned, the accommodation judgment section 20c selects an IP telephone terminal-accommodating interface being able to accommodate the IP telephone terminal, which is the sender of the connection request (step S34). The accommodation judgment section 20c sends a connection response including the IP address of the IP telephone terminal-accommodating interface back to the IP telephone terminal. The IP address of the selected accommodation interface is newly registered in the database 20b.

In step S34, there are several selection methods based on settings, states, etc. of the IP telephone terminal-accommodating interfaces 21 and 22. For example, the accommodation interfaces may be determined so that loads on the IP telephone terminal-accommodating interfaces 21 and 22 are averaged. Or, unless the number of IP telephone terminals accommodated in one of the IP telephone terminal-accommodating interfaces 21 and 22 reaches a predetermined number, one and the same interface may be determined as the accommodation interface. Or, either of the IP telephone terminal-accommodating interfaces 21 and 22 may be assigned at random. Although several selection methods are conceived as described above, these selection methods may be provided so that one of the selection methods can be selected freely switchably in accordance with settings of the system. A procedure of processing at the time of occurrence of failure will be described next.

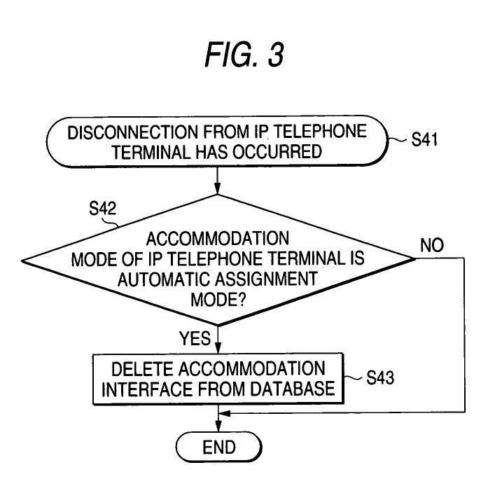

FIG. 3 is a flow chart showing a procedure of processing in the exchange 200 shown in FIG. 1. After connection to an IP telephone terminal is established, the accommodation judgment section 20c of the exchange 200 checks the connection periodically. The accommodation judgment section 20c detects failure, etc. of the IP telephone terminal by the connection check. When disconnection from the IP telephone terminal is detected (step S41), the accommodation judgment section 20c searches the database 20b to judge the accommodation mode of the IP telephone terminal, which is the sender of the connection request (step S42). When the accommodation mode is the automatic assignment mode, the accommodation judgment section 20c deletes information about the accommodation interface for the IP telephone terminal where failure has occurred, from the database 20b (step S43). In this manner, the IP telephone terminal where failure has occurred is once excluded from accommodation in the exchange 200.

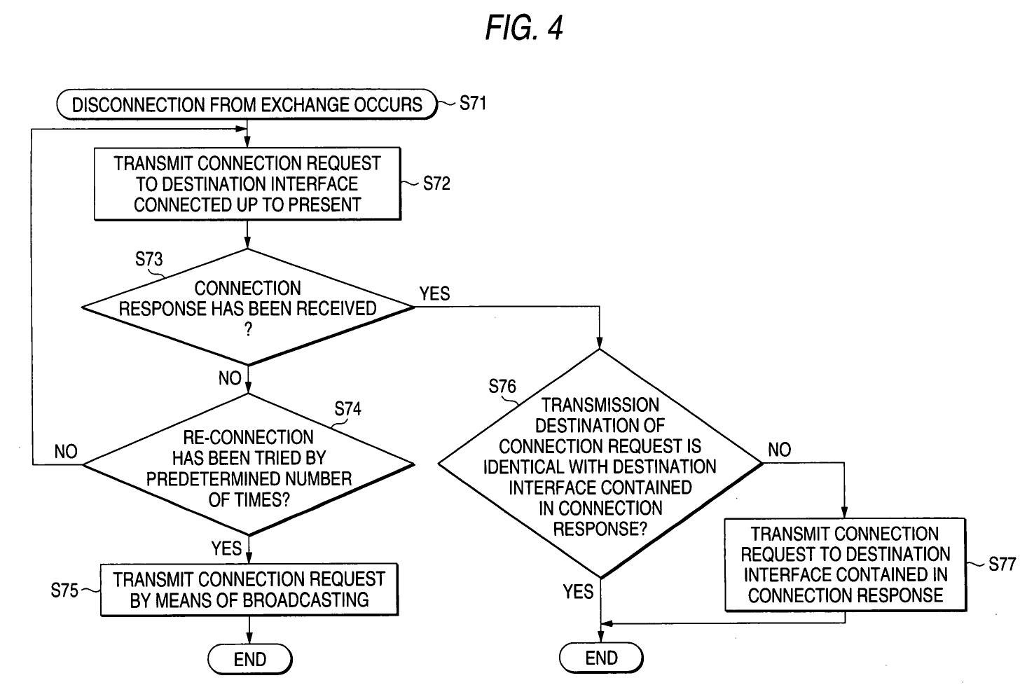

FIG. 4 is a flow chart showing a procedure of processing in the IP telephone terminal 101 shown in FIG. 1. In FIG. 4, after connection to the exchange 200 is established, the connection processing section 10c of the IP telephone terminal checks the connection periodically. The connection processing section 10c detects failure, etc. of the IP telephone terminal-accommodating interface of the exchange 200 by the connection check. When disconnection from the exchange 200 is detected (step S71), the connection processing section 10c transmits a connection request to the destination interface connected up to that time (step S72) to try re-connection.

Upon reception of a connection response to the connection request (step S73), the connection processing section 10c judges whether the IP address of the destination interface designated by the connection request is identical to the IP address of the destination interface designated by the connection response or not (step S76). When the both are not identical to each other, the connection processing section 10c transmits a connection request to the IP telephone terminal-accommodating interface indicated by the connection response (step S77).

When connection to the destination interface is not established in spite of repetition of the re-connection trial by a predetermined number of times in the loop of the Steps S72 to S74 (YES in the Step 74), the connection processing section 10c transmits a connection request to all of the IP telephone terminal-accommodating interfaces by means of broadcasting (step S75).

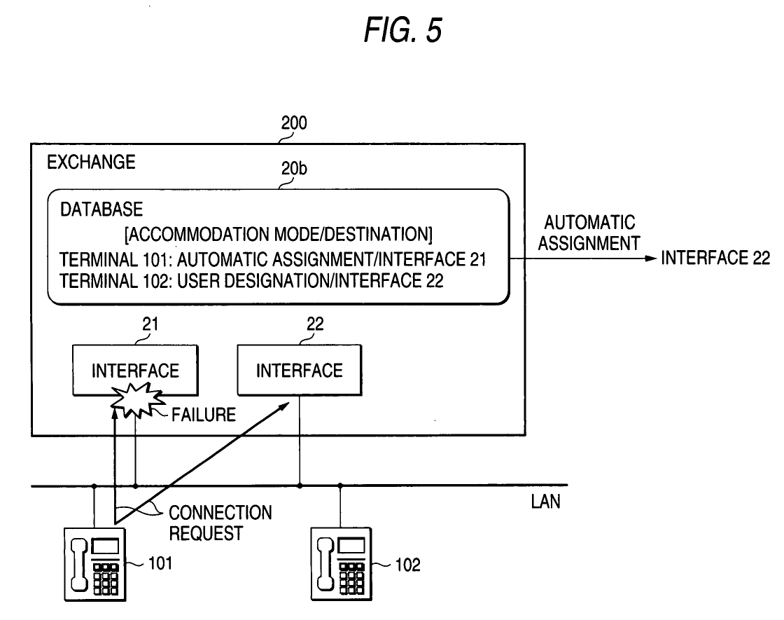

FIG. 5 is a typical view showing a process at the time of occurrence of failure. When the IP telephone terminal 101 detects failure of the destination interface 21, the IP telephone terminal 101 broadcasts a connection request. Upon reception of the connection request, the IP telephone terminal-accommodating interface 22 without any failure processes the connection request. The exchange 200 identifies the sender terminal from the connection request and judges the accommodation mode of the IP telephone terminal 10l by referring to the database 20b. Since the terminal 101 is in the automatic assignment mode, the exchange 200 changes the accommodation interface of the IP telephone terminal 101 from the IP telephone terminal-accommodating interface 21 to the IP telephone terminal-accommodating interface 22 immediately. This change is also reflected on the contents of the database 20b, so that the database 20b is updated. By this operation, a measure can be taken immediately when failure occurs in any one of the IP telephone terminal-accommodating interfaces 21 and 22 of the exchange 200. That is, unexpected (unintentional) change of the accommodation interface can be automated so that both reliability and maintainability of the telephone system can be improved.

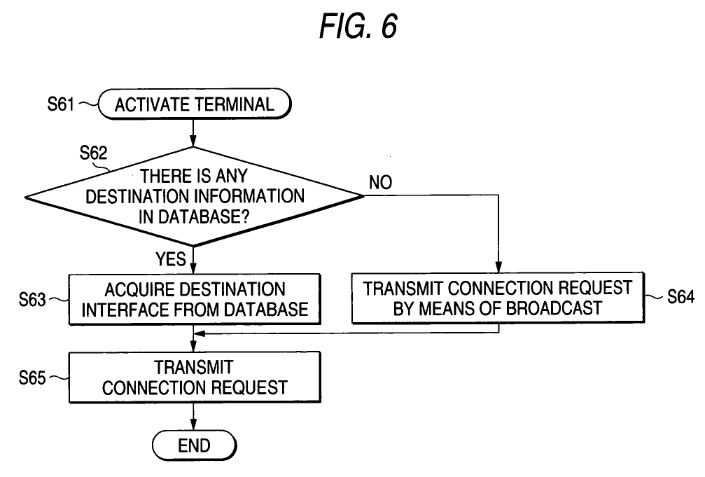

FIG. 6 is a flow chart showing another procedure of processing in the IP telephone terminal 101 shown in FIG. 1. When an IP telephone terminal is introduced into the system and activated (step S61), the connection processing section 10c refers to the destination database 10a to judge whether the IP address of a destination interface has been registered or not (step S62) When the IP address has been already registered, the connection processing section 10c acquires the IP address (step S63) and transmits a connection request to the acquired IP address (step S65). When there is no registration information in the destination database 10a (NO at step S62), the connection processing section 10c transmits a connection request to all the IP telephone terminal-accommodating interfaces by means of broadcasting (step S64).

According to the aforementioned configuration and operation, connection can be established in accordance with the database 20b in the exchange 200 even when the accommodation interface of the database 20b in the exchange 200 is inconsistent with information in the destination database 10a in the IP telephone terminal, or even when there is no registration information in the destination database 10a.

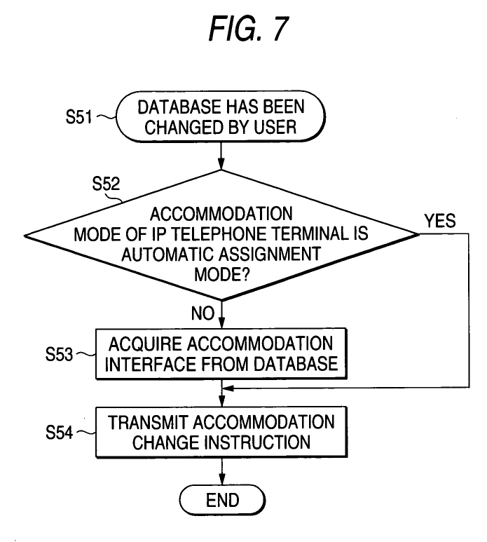

FIG. 7 is a flow chart showing another procedure of processing in the exchange 200 shown in FIG. 1. When the database 20b of the exchange 200 is changed by a user's operation through the user interface 20a in step S51 in FIG. 7, the accommodation judgment section 20c judges the accommodation mode of the changed IP telephone terminal (step S52). Here, when the accommodation mode is the user designation mode (No at step S52), the accommodation judgment section 20c acquires the IP address of the changed accommodation interface (step S53), and transmits an accommodation change instruction including the IP address to the IP telephone terminal as a subject of change.

Specifically, the procedure shown in FIG. 7 is carried out in the following cases (1) and (2).

(1) The case where connection to the exchange 200 is established and the accommodation interface for the IP telephone terminal, which is in the user designation mode selected as the accommodation mode, is changed by a user's operation.

(2) The case where connection to the exchange 200 is established and the automatic assignment mode as the accommodation mode of the IP telephone terminal is changed to the user designation mode by a user's operation. Incidentally, the case (2) is limited to the case where the new accommodation interface set with the change of the accommodation mode to the user designation mode is different from the accommodation interface currently connected.

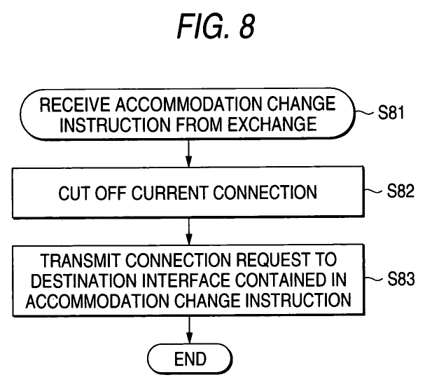

FIG. 8 is a flow chart showing another procedure of processing in the IP telephone terminal 101 shown in FIG. 1. In FIG. 8, upon reception of an accommodation change instruction from the exchange 200 (step S81), the connection processing section 10c of the IP telephone terminal cuts off the current connection (step S82). The connection processing section 10c transmits a connection request to the IP address of the destination interface contained in the accommodation change instruction (step S83). By these operations, the accommodation interface of the IP telephone terminal can be changed intentionally in accordance with user's setting. The aforementioned procedure is effective in an operation of replacing the failure interface by exchanging a board for a new one. That is, at the time of failure of any interface, all the IP telephone terminals are connected to interfaces without any failure. There is a merit that it is easy to change the configuration or extend the system.

In this embodiment, either of a user designation mode in which accommodation interfaces are explicitly assigned to IP telephone terminals according to a user's designation and an automatic assignment mode in which the accommodation interfaces are unexplicitly assigned to the IP telephone terminal can be selected/designated for each IP telephone terminal. Information indicating the accommodation mode for each IP telephone terminal is registered in a database of the exchange 200. When there is no response in spite of repetition of transmission of a connection request by several times, the IP telephone terminal sends a connection request to all the accommodation interfaces by means of broadcasting. Upon reception of the connection request from the IP telephone terminal in the automatic assignment mode by means of broadcasting,.the exchange 200 selects an appropriate one from among the interfaces being able to accommodate the IP telephone terminal at that time, and sends the IP address of the selected IP telephone terminal-accommodating interface back to the IP telephone terminal.

By these operations, the interface for accommodating the telephone terminal can be changed immediately even at the time of occurrence of interface failure. As a result, it is possible to provide a telephone system with improved maintainability.

Incidentally, the invention is not limited to this embodiment. For example, the method by which the connection processing section 10c of the IP telephone terminal sends out a connection request at the time of interface failure, etc. is not limited to broadcasting. For example, an accommodating interface having no response may send out a connection request to a next accommodating interface successively. Or another IP telephone terminal may be provided so as to relay the connection request. For example, in FIG. 2, the IP telephone terminal 101 sends out a connection request to the IP telephone terminal 102 when there is no response from the interface 21. The IP telephone terminal 102 transfers the connection request to the interface 22 by relaying the connection request. Since there is no failure in the interface 22, the connection request from the IP telephone terminal 101 can be transmitted to the exchange 200 without accident.

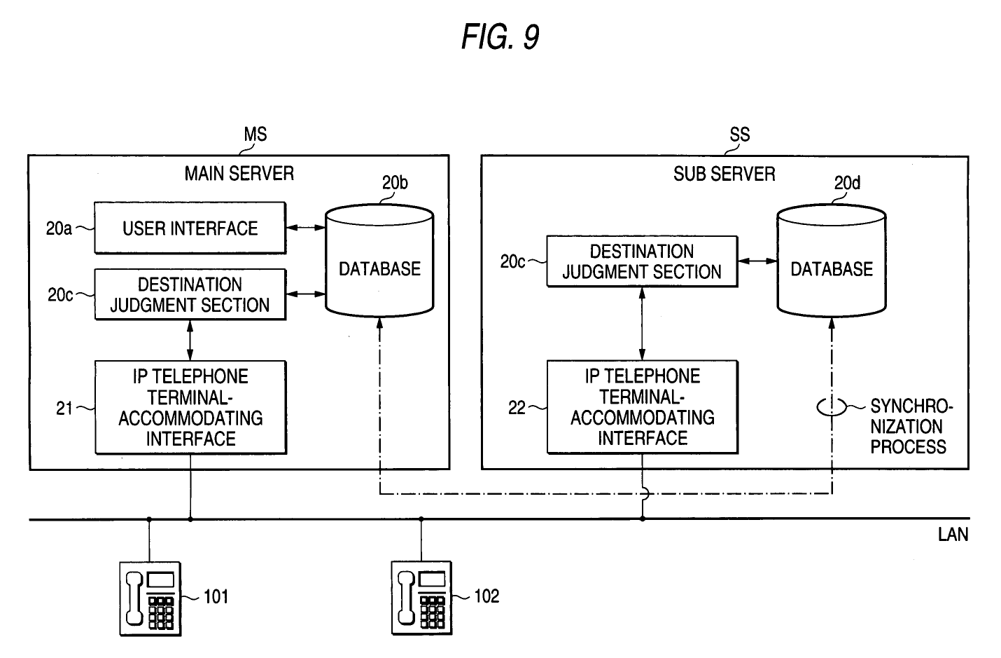

The invention is also applicable to a system having a combination of a plurality of server type exchanges. As shown in FIG. 9, each of exchanges obtained by installing a dedicated application into servers may be provided with only one IP telephone terminal-accommodating interface due to the hardware constraint thereof. Such server apparatuses (a main server MS and a sub server SS) can cooperate with each other to form a switching system. In the system shown in FIG. 9, there are a plurality of destination interfaces in view from the IP telephone terminals 101 and 102. It is therefore necessary to decide correspondence relation between the destination interfaces and the IP telephone terminals.

When the main server MS and the sub server SS in the system shown in FIG. 9 are configured as shown in FIG. 1, the invention is applicable to the system. In this case, the database 20b of the main server MS and the Database 20d of the sub server SS may be synchronized with each other.

The invention is not limited to the embodiments directly, but may be given shape by modifying constituent members without departing from the gist of the invention. Appropriate combinations of a plurality of constituent members disclosed in the embodiments may form various inventions. For example, some of the whole constituent members shown in the embodiments may be removed.

What is claimed is:

1. A switching system used in a telephone system including a plurality of terminal devices each of which transmits/receives packetized voice information to/from a destination terminal device through a packet communication network, the switching system comprising:
a plurality of communication interfaces that accommodate the plurality of terminal devices under accommodation modes, each of which is selected for each terminal device from the group consisting of a first mode in which the communication interfaces are explicitly assigned to the plurality of terminal devices and a second mode in which the communication interfaces are unexplicitly assigned to the plurality of terminal devices;
a detection unit that detects whether or not failure occurs in each communication interface;
a terminal setting database that associates each terminal device with the accommodation mode selected for each terminal device and the communication interface accommodating each terminal device;
a judgment unit that upon reception of a connection request message transmitted from each terminal device, judges the accommodation mode of each the terminal device by referring to the terminal setting database;
a determination unit, when the judgment unit judges that the accommodation mode of each terminal device is the first mode and failure occurs in a communication interface having been assigned to each terminal device, the determination unit determining another communication interface, which accommodates each terminal device, from among communication interfaces in which the detection unit detects that failure does not occur; and
a send-back unit that sends a response message including an identifier of the communication interface determined by the determination unit to each terminal device through the packet communication network.

2. The switching system according to claim 1, wherein:
the judgment unit judges whether or not a connection between each communication interface and the terminal devices assigned to each communication interface is disconnected; and
when the judgment unit judges that the connection between one of the communication interfaces and a terminal device assigned to the one of the communication interfaces is disconnected, the judgment unit judges whether or not an accommodation mode of the terminal device assigned to the one of the communication interfaces is the second mode; and
when the judgment unit judges that the accommodation mode of the terminal device assigned to the one of the communication interfaces is the second mode, the judgment unit deletes an association relation between the one of the communication interfaces and the terminal device from the terminal setting database.

3. The switching system according to claim 1, further comprising:
a user interface that allows a user to enter an instruction, wherein:
when upon reception of an user's instruction of changing an accommodation mode of a terminal device through the user interface, the judgment unit judges whether or not the accommodation mode is changed to the first mode, and
when the judgment unit judges that the accommodation mode is changed to the first mode, the send-back unit sends a change instruction message including an identifier of a communication interface indicated by the user's instruction to the terminal device indicated by the user's instruction.

4. A telephone system comprising:
a plurality of terminal devices each of which transmits/receives packetized voice information to/from a destination terminal device through a packet communication network; and
a switching system of claim 1 that connects the plurality of terminal devices to each other, wherein:
each of the terminal devices includes a transmission unit that transmits the connection request message to the communication interface assigned to each of the terminal devices under the first mode and transmits the connection request message to at least one of the communication interfaces under the second mode, and
when each of the terminal devices has not received the response message to the connection request message even if the transmission unit has transmitted the connection request message predetermined number of times, the transmission unit transmits the connection request message to at least one of the communication interfaces except the communication interface assigned to the each of the terminal devices.

5. The telephone system according to claim 4, wherein the transmission unit broadcasts the connection request message to all the communication interfaces.

6. The telephone system according to claim 4, wherein the transmission unit transmits the connection request message the communication interfaces successively.

7. The telephone system according to claim 4, wherein:
each of the terminal devices further includes a relay unit that relays to the switching system the connection request message transmitted from another terminal device, and
the transmission unit transmits the connection request message to another terminal device.

8. A management method of a telephone system including:
a plurality of terminal devices each of which transmits/receives packetized voice information to/from a destination terminal device through a packet communication network; and
a switching system that connects the plurality of terminal devices to each other, the switching system having:
a plurality of communication interfaces that accommodate the plurality of terminal devices under accommodation modes, each of which is selected for each terminal device from the group consisting of a first mode in which the communication interfaces are explicitly assigned to the plurality of terminal devices and a second mode in which the communication interfaces are unexplicitly assigned to the plurality of terminal devices; and
a terminal setting database that associates each terminal device with the accommodation mode selected for each terminal device and the communication interface accommodating each terminal device;
the method comprising:
transmitting a connection request message from each of the terminal devices to the communication interface assigned to each of the terminal devices under the first mode;
transmitting the connection request message from each of the terminal devices to at least one of the communication interfaces under the second mode;
detecting whether or not failure occurs in each communication interface;
receiving a connection request message transmitted from each terminal device and then referring to the terminal setting database to judge the accommodation mode of the terminal device transmitting the connection request message;
if it is judged the accommodation mode of the terminal device transmitting the connection request message is the first mode and that failure occurs in a communication interface having been assigned to the terminal device transmitting the connection request message, determining another communication interface, which accommodates the terminal device transmitting the connection request message, from among communication interfaces in which it is detected that failure does not occur;
sending a response message including an identifier of the communication interface determined to the terminal device transmitting the connection request message through the packet communication network; and
if each of the terminal devices has not received the response message to the connection request message even though the connection request message is transmitted from each of the terminal devices predetermined number of times, transmitting the connection request message from each of the terminal devices to at least one of the communication interfaces except the communication interface assigned to the each of the terminal devices.
